(19) United States
(12) Patent Application Publication
(10) Pub. No.: US 2022/0277320 A1
(43) Pub. Date: Sep. 1, 2022

(54) INFORMATION PROCESSING APPARATUS, INFORMATION PROCESSING METHOD, AND NON-TRANSITORY COMPUTER READABLE MEDIUM

(71) Applicant: FUJIFILM BUSINESS INNOVATION CORP., Tokyo (JP)

(72) Inventors: Kengo TOKUCHI, Kanagawa (JP); Yuta NAKAMORI, Tokyo (JP)

(73) Assignee: FUJIFILM BUSINESS INNOVATION CORP., Tokyo (JP)

(21) Appl. No.: 17/384,170

(22) Filed: Jul. 23, 2021

(30) Foreign Application Priority Data
Feb. 26, 2021 (JP) 2021-030422

(51) Int. Cl. G06Q 30/02; G06F 16/9535; G06Q 20/40; G10L 15/00; G10L 17/00

(52) U.S. Cl. CPC G06Q 30/0201; G06F 16/9535; G06Q 20/40145; G10L 15/005; G10L 17/00; G06F 21/31

(57) ABSTRACT

An information processing apparatus includes a processor configured to, on a basis of first information indicating an activity history regarding at least one user in real space, acquire second information present in Internet space and indicating an activity history regarding the at least one user.

### CROSS-REFERENCE TO RELATED APPLICATIONS

This application is based on and claims priority under 35 USC 119 from Japanese Patent Application No. 2021-030422 filed Feb. 26, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2020-9226 describes a system that acquires information regarding a parameter input to a format displayed by a user terminal, acquires a user's activity history continuously transmitted from the user terminal, and calculates credit scores on the basis of the parameter and the activity history.

Japanese Unexamined Patent Application Publication No. 2017-204308 describes an apparatus that extracts, for each of identifiers of respective users, information regarding a history in which each user uses one or more web services provided through one or more web sites. From a memory storing information regarding the users' use histories, the information is extracted as credit information used for loan screening to be performed for the user.

Japanese Unexamined Patent Application Publication (Translation of PCT Application) No. 2020-502677 describes a method in which the credit score and the propensity score of a specific user is decided for a specific service and in which a comprehensive credit score of the specific user is thereafter decided on the basis of credit scores and propensity scores of the specific user that are decided for various types of services.

Japanese Unexamined Patent Application Publication (Translation of PCT Application) No. 2018-514829 describes a login method performed in the following manner. Specifically, activity components receive information regarding accounts simultaneously becoming online and transfer the account information to respective service components in different processes via binding instances, and login is executed by the service components in accordance with the account information.

### SUMMARY

Aspects of non-limiting embodiments of the present disclosure relate to acquiring information indicating an activity history in the Internet space regarding a user in the real space.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor configured to, on a basis of first information indicating an activity history regarding at least one user in real space, acquire second information present in Internet space and indicating an activity history regarding the at least one user.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to this exemplary embodiment;

FIG. 2 is a block diagram illustrating the configuration of a server;

FIG. 3 is a block diagram illustrating the configuration of a terminal apparatus;

FIG. 4 is a view illustrating an activity history regarding a user in the real space;

FIG. 5 is a flowchart illustrating a user evaluation process;

FIG. 6 is a flowchart illustrating a user evaluation process; and

FIG. 7 is a flowchart illustrating a user evaluation process.

### DETAILED DESCRIPTION

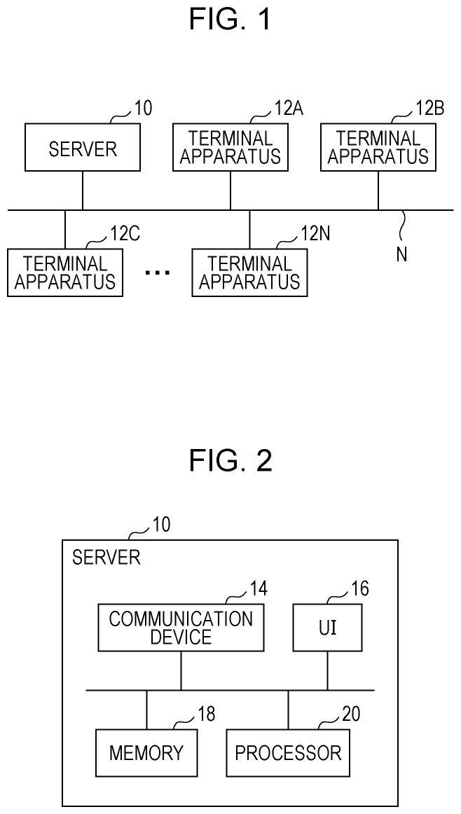

An information processing system according to this exemplary embodiment will be described with reference to FIG. 1. FIG. 1 illustrates an example configuration of the information processing system according to this exemplary embodiment.

The information processing system according to this exemplary embodiment includes, for example, a server 10 and N terminal apparatuses (N is an integer of 1 or larger). In the example illustrated in FIG. 1, the information processing system according to this exemplary embodiment includes terminal apparatuses 12A, 12B, 12C, . . . and 12N. The number of the terminal apparatuses illustrated in FIG. 1 is merely an example, and it suffices that one or more terminal apparatuses are included in the information processing system according to this exemplary embodiment. When there is no need for mutual distinction in the following description, each of the terminal apparatuses 12A, 12B, 12C, . . . and 12N is referred to as a terminal apparatus 12. The information processing system according to this exemplary embodiment may include the server 10 and an apparatus other than the terminal apparatus 12.

The server 10 and the terminal apparatus 12 each have a function of communicating with a different apparatus. The communication may be wired communication using a cable or may be wireless communication. In other words, each apparatus may transmit and receive information in such a manner as to be physically connected to the different apparatus or through the wireless communication. Examples of the wireless communication include short distance wireless communication or Wi-Fi (registered trademark). Examples of the short distance wireless communication include Bluetooth (registered trademark), radio frequency identifier (RFID), and near field communication (NFC). For example, the apparatus may communicate with the different apparatus via a communication path N such as a local area network (LAN) or the Internet.

In this exemplary embodiment, first information indicates an activity history regarding a user in the real space, and second information present in the Internet space indicates the activity history regarding the user. The second information is acquired on the basis of the first information. A process for acquiring the second information may be executed by the server 10, by a terminal apparatus 12 used by the user, or by a terminal apparatus 12 used by a different user.

For example, the first information is input to a terminal apparatus 12 and is transmitted from the terminal apparatus 12 to the server 10. The second information is acquired by the server 10 on the basis of the first information and is transmitted from the server 10 to the terminal apparatus 12. The second information may be acquired by the terminal apparatus 12 on the basis of the first information.

One or more items for the activity history regarding the user in the real space are specified, and information regarding the one or more items is included in the first information regarding the user. Examples of one or more items included in the first information include: an item for identifying a user (such as a name, identification (ID), a nickname used in the real space, or a nickname or an account used in the Internet space); gender; age; an address; a residence; a birthplace; an occupation; a place of business; a hobby; a friend; a group to which the user belongs; a service used by the user (such as a service provided in the real space and a service provided on the Internet); a purchasing and selling history in the real space; the location of the user (a location acquired by, for example, a global positioning system (GPS) or other systems); the image of the user (such as the image of the face of the user, an image from the waist up, or a full-length image); working hours; gaming hours; biometric information; a lifestyle; and other activity histories in the real space regarding the user. Information indicating an activity history other than these may be included in the first information. For example, the first information may be acquired from a questionnaire answered by the user, the personal history of the user, or other documents.

One or more items for the activity history present in the Internet space regarding the user are specified, and information regarding the one or more items are included in the second information regarding the user. Examples of one or more items included in the second information include: an item for identifying a user (such as a name, an ID, or a nickname or an account used in the Internet space); a purchasing and selling history in the Internet space; a service used by the user in the Internet space (for example, an online service); a history of using a social network service (SNS) (such as a history of browsing a SNS, a posting history, a followed account, followers, or a friend in the SNS); a history of purchasing and selling an account of the user (for example, an account used in the Internet space); a history of using a web site (such as a history of browsing or creating a web site); gender; age; an address; a residence; a birthplace; an occupation; a place of business; a hobby; a friend; a group to which the user belongs; biometric information; and other user activity histories in the Internet space. Information indicating an activity history other than these, for example, information indicating a history of an activity in the SNS (for example, time line information in a certain period of time) may be included in the second information.

The biometric information may include various pieces of information from an organism. Examples of the biometric information include: information indicating a brain action (such as brain waves, the blood flow volume of the brain, or a brain magnetic field signal); information indicating a pulse rate; electromyogram information such as electromyogram waveforms, saliva information (for example, information indicating an amount of saliva); information indicating a pulse wave, a blood pressure, a blood flow volume, pulsation, a heart rate, an electrocardiographic complex, an eye movement, body temperature, an amount of perspiration, a line of sight, voice, the movement of a person, or an expression of a person; information determined by a biomarker; information indicating breathing or a finger print; and information acquired from body fluids (such as blood). The biometric information may also be information attributed to a potential detected from the organism. For example, the biometric information may be brain waves representing the measurement result of minute electric current accompanying brain actions, an electrocardiogram representing the measurement result of minute electric current accompanying heart beats, electromyogram representing the measurement result of minute electric current accompanying muscle actions, a skin potential representing the measurement result of minute electric current generated on the skin, or other pieces of information. These are merely examples of the biometric information, and biometric information other than these may be used.

The biometric information may be analyzed to thereby obtain emotion information, mentality information, psychological information, or the like serving as an example of a person's state information. The emotion information, the mentality information, or the psychological information may be included in the first information or the second information. For example, the biometric information regarding a person may be analyzed to thereby obtain information indicating an emotion of the person, information indicating the state of mentality of the person, information indicating the psychological state of the person, or the like. It goes without saying that biometric information regarding an animal or a plant other than a person may be analyzed to thereby obtain information indicating the state of the animal or the plant other than the person. Examples of the state information regarding a person include appetite, desire for sleep, and sexual desire as three major desires and a sense mainly represented by a feeling, more specifically, information indicating, for example, relief, uneasiness, gratitude, astonishment, excitement, sexual excitement, curiosity, sexual curiosity, calmness, fretfulness (impatience), a strange feeling (puzzlement), happiness, luckiness, relax, tension, honor, responsibility, respect, intimacy (familiarity), yearning (longing), desire (eagerness), terror, courage, comfort, pleasure (in good conduct or virtue), regret, satisfaction, dissatisfaction, frustration, disgust, shame, contempt, envy, guilt, murderous intent, Shadenfreude, saudade, expectation, a superiority complex, an inferiority complex, malice, a grudge, pain, sadness, a heartrending sorrow, affection, anger (agony, anguish, and anxiety), resignation (reconciliation), despair, hope, hatred (love and hate), affectionateness, or emptiness. The state information also include itching, an ache, a desire to urinate, a defecation desire, hunger, a feeling of fullness, and the like. In addition, information for communication between persons includes information regarding a thought or an intention of a person, for example, approval, agreement, opposition, rejection, perplexity, or confusion.

For example, biometric information is measured when the user acts in the real space, and the measured biometric information is included in the first information. In a specific example, biometric information is measured when the user does shopping, and the biometric information is included in the first information.

The server 10 may provide an online service via the communication path N. A different server other than the server 10 may provide an online service. The user may use the online service by using the terminal apparatus 12.

Examples of the online service include services for respectively providing an online storage, an online meeting, content online, an online game, and online shopping, a SNS, and combination of at least two of these. The online meeting is referred to as a web meeting, a remote meeting, a video meeting, or the like on occasions. Examples of the content include entertainment (such as a concert, a play, a movie, video, or music), sports, and e-sports. A video streaming service or music streaming service are examples of the service for providing content online. The user may enjoy the entertainment, sports, or e-sports online.

The online service may be a service using a virtual space or not using a virtual space. The virtual space is a concept compared with the real space. Examples of the virtual space include a virtual space created by a computer, on a network such as the Internet, or by virtual reality (VR) technology, and a cyber space. A virtual three-dimensional or two-dimensional space corresponds to an example of the virtual space.

The terminal apparatus 12 is, for example, a personal computer (hereinafter, referred to as a PC), a tablet PC, a smartphone, a wearable device (such as augmented reality (AR) glasses, virtual reality (VR) glasses, mixed reality (MR) glasses, or a bearable device), or a mobile phone.

Hereinafter, the hardware configuration of the server 10 will be described with reference to FIG. 2. FIG. 2 illustrates an example hardware configuration of the server 10.

The server 10 includes, for example, a communication device 14, a user interface (UI) 16, a memory 18, and a processor 20.

The communication device 14 is a communication interface including a communication chip or a communication circuit and has functions of transmitting and receiving information to and from a different apparatus. The communication device 14 may have a wireless communication function and may have a wired communication function. The communication device 14 may communicate with the different apparatus, for example, by using the short distance wireless communication or through the communication path N.

The UI 16 includes at least one of a display and an input device. The display is a liquid crystal display, an electroluminescence (EL) display, or the like. The input device is a keyboard, a mouse, an input key, an operation panel, or the like. The UI 16 may be a UI such as a touch panel serving as the display and the input device.

The memory 18 is a device configured as one or more memory areas where data is stored. The memory 18 is, for example, a hard disk drive, any one of various memories (such as a random-access memory (RAM), a dynamic RAM (DRAM), and a read-only memory (ROM)), any one of other memory devices (such as an optical disk), or combination of these. The server 10 includes one or more memories 18.

The processor 20 is configured to control operations of the components of the server 10. The processor 20 may have a memory. For example, the processor 20 provides the user with an online service. Note that an online service may be provided by an apparatus different from the server 10, without being provided from the processor 20.

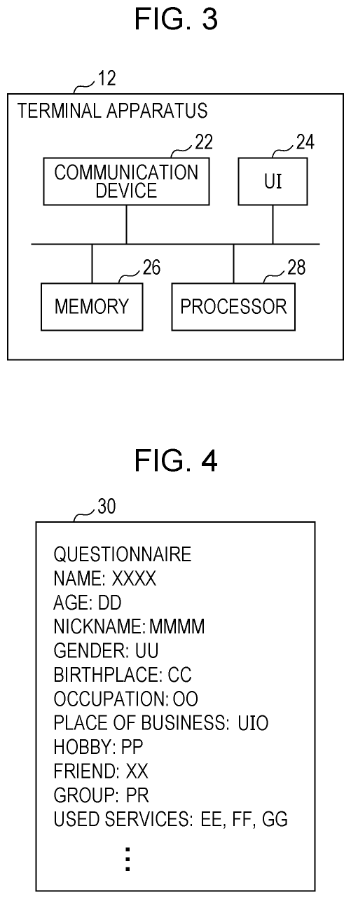

Hereinafter, the hardware configuration of the terminal apparatus 12 will be described with reference to FIG. 3. FIG. 3 illustrates an example hardware configuration of the terminal apparatus 12.

The terminal apparatus 12 includes, for example, a communication device 22, a UI 24, a memory 26, and a processor 28.

The communication device 22 is a communication interface including a communication chip or a communication circuit and has functions of transmitting and receiving information to and from a different apparatus. The communication device 22 may have a wireless communication function and may have a wired communication function. The communication device 22 may communicate with the different apparatus, for example, by using the short distance wireless communication or through the communication path N.

The UI 24 includes at least one of a display and an input device. The display is a liquid crystal display, an EL display, or the like. The input device is a keyboard, a mouse, an input key, an operation panel, or the like. The UI 24 may be a UI such as a touch panel serving as the display and the input device. The UI 24 may include a microphone or a speaker. The terminal apparatus 12 may include an imaging device such as a camera.

The memory 26 is a device configured as one or more memory areas where data is stored. The memory 26 is, for example, a hard disk drive, any one of various memories (such as a RAM, a DRAM, and a ROM), any one of other memory devices (such as an optical disk), or combination of these. The terminal apparatus 12 includes one or more memories 26.

The processor 28 is configured to control operations of the components of the terminal apparatus 12. The processor 28 may have a memory.

Hereinafter, this exemplary embodiment will be described in detail. Processes according to this exemplary embodiment may be executed by any one of the processor 20 of the server 10 and the processor 28 of the terminal apparatus 12 or in cooperation between the processor 20 and the processor 28. Part of one of the processes may be executed by the processor 20, and the other part thereof may be executed by the processor 28. Note that the server 10, the terminal apparatus 12, or combination of these corresponds to an example of an information processing apparatus according to this exemplary embodiment.

The first information will be described with reference to FIG. 4. FIG. 4 illustrates an example of the first information. First information 30 illustrated in FIG. 4 is information indicating an activity history regarding a user A in the real space and includes information regarding items for the first information. For example, the first information 30 includes information regarding items that are the name of the user A, the age, the nickname, the gender, the birthplace, the occupation, the place of business, a hobby, a friend, a group to which the user A belongs, and services used by the user A.

For example, the user A is provided with a questionnaire having items included in the first information and answers the questionnaire regarding the items. The user A answers the entirety or part of the items included in the questionnaire. The user A may be provided with a paper sheet for the questionnaire and answer the items on the paper sheet. Alternatively, an image representing the questionnaire may be displayed on the display of the terminal apparatus 12A used by the user A, and the user A may answer the items on the screen. If the user A answers the items on the paper sheet, the first information 30 indicating the answers is generated in such a manner that the paper sheet is read with a scanner, a camera, or other devices and data regarding the answers to the items is generated. If the user A answers the items on the screen, the first information 30 indicating the answers to the items is generated by the processor 28 of the terminal apparatus 12A.

For example, the processor 28 of the terminal apparatus 12A herein transmits the first information 30 to the server 10. On the basis of the first information 30 transmitted from the terminal apparatus 12A, the processor 20 of the server 10 acquires the second information present in the Internet space and indicating an activity history regarding the user A.

The processor 20 of the server 10 infers an activity history regarding the user A in the real space on the basis of the information regarding the items included in the first information 30 and infers, as an activity history in the Internet space regarding the user A, an activity history in the Internet space corresponding to the activity history in the real space. The processor 20 then acquires information indicating the activity history in the Internet space from the Internet space, as the second information regarding the user A. For example, the processor 20 of the server 10 acquires, as the second information regarding the user A, information inferred as a post by the user A in a SNS, information indicating a history of purchasing a commodity or a service inferred as a commodity or a service purchased by the user A in the Internet space, information regarding a service inferred as a service used by the user A in the Internet space, and other pieces of information. It goes without saying that information other than these pieces of information may be acquired as the second information. The second information may be information managed by the server 10 or by an apparatus other than the server 10.

When the second information has items the content of which coincides with the content of the items in the first information 30 and the number of which is larger than or equal to a threshold, the processor 20 of the server 10 may infer the second information as the second information regarding the user A and acquire the inferred second information. For example, suppose a case where second information including items having the following content is present in the Internet space. Specifically, the content of the items coincides with the content of items A, B, C, and D included in the first information 30. In this case, the processor 20 of the server 10 infers the second information as the second information regarding the user A and acquires the second information.

The processor 20 of the server 10 may make an inquiry to the user A about what the user A needs to know to validate an activity history indicated by the second information, include the answer from the user A to the inquiry in the first information 30, and acquire the second information on the basis of the first information 30. For example, information indicating the inquiry is displayed on the display of the terminal apparatus 12A, and the user A answers the inquiry. For example, if the second information is information indicating an activity history representing an online game has been beaten, the processor 20 of the server 10 inquires of the user A about a condition for beating the online game. If the user A successfully answers the inquiry about the condition, the processor 20 of the server 10 infers that the user A has beaten the online game and acquires, as the second information regarding the user A, the second information indicating that the online game has been beaten.

If more than one user uses one account, the processor 20 of the server 10 may acquire the second information for each of the users after discriminating the users. For example, the user A and users B and C use an online service or the like after logging in the terminal apparatus 12A by using the account of the user A. The users A, B, and C may log in the terminal apparatus 12A by using the account of the user A at the same time of day or at different times of day. The processor 20 of the server 10 discriminates the users A, B, and C from each other and separately acquires pieces of second information regarding the respective users A, B, and C.

For example, the processor 20 of the server 10 discriminates each user on the basis of a language used by a corresponding one of the users A, B, and C, a favorite phrase of the corresponding one of the users A, B, and C, the time of day when the corresponding one of the users A, B, and C logs in the terminal apparatus 12A, the time of day when the corresponding one of the users A, B, and C uses the online service, or the like.

For example, when the users A, B, and C use an online service (for example, an online meeting) with their voices uttered, the voice of each user is recorded by a microphone, and data regarding the voice of the user is transmitted from the terminal apparatus 12A to the server 10. The processor 20 of the server 10 analyzes the data regarding the voice of the user, thereby infers the language, the favorite phrase, or the dialect used by the corresponding one of the users A, B, and C, and discriminates the user on the basis of the inference result.

The processor 20 of the server 10 may discriminate the users on the basis of the time of day when they log in the terminal apparatus 12A by using the same account. For example, the processor 20 of the server 10 regards the users who perform login at different times of day as respective different users and discriminates the users.

The processor 20 of the server 10 may discriminate each of the users A, B, and C on the basis of comprehensive information including the language used by a corresponding one of the users A, B, and C, a favorite phrase thereof, the time of day when they log in the terminal apparatus 12A, the time of day when they use the online service, and the like.

The processor 20 of the server 10 regards the discriminated users A, B, and C as respective different users and acquires the second information regarding each of the users A, B, and C.

The second information may include information indicating an activity history regarding an agent (such as an importer for purchasing an imported commodity on behalf of the user A or a dealer for outsourcing creation of a work such as music or a picture) who acts on behalf of the user A in the Internet space by using the account of the user A. In other words, the processor 20 of the server 10 infers, as an activity history in the Internet space regarding the user A, an activity history regarding an agent who acts in the Internet space by using the account of the user A and acquires, as the second information regarding the user A, the information indicating the activity history.

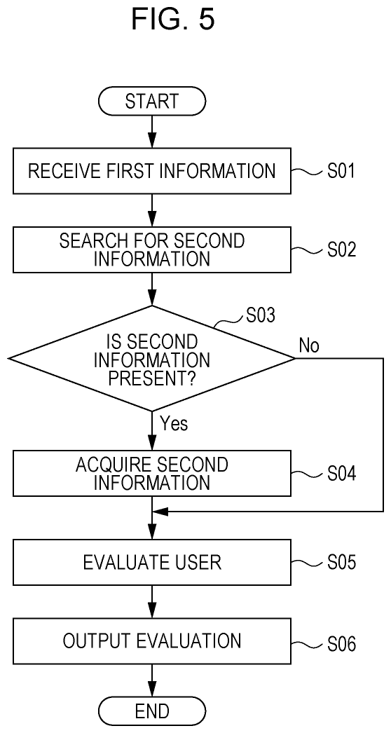

The processor 20 of the server 10 may evaluate the user A on the basis of the first information and the second information regarding the user A. Hereinafter, an evaluation process will be described with reference to FIG. 5. FIG. 5 illustrates a flowchart of the evaluation process.

First, the first information regarding the user A is transmitted from the terminal apparatus 12A to the server 10 (S01). For example, information indicating answer to the questionnaire, a personal history, or the like is included in the first information and is transmitted from the terminal apparatus 12A to the server 10, and the processor 20 of the server 10 receives the first information.

After receiving the first information regarding the user A from the terminal apparatus 12A, the processor 20 of the server 10 searches for second information regarding the user A indicating an activity history in the Internet space, on the basis of the first information (S02).

If the second information regarding the user A indicating the activity history is present in the Internet space (Yes in S03), the processor 20 of the server 10 acquires the second information (S04) and evaluates the user A on the basis of the first information and the second information (S05). Specifically, the processor 20 of the server 10 evaluates the user A on the basis of an activity history regarding the user A in the real space indicated by the first information and an activity history in the Internet space regarding the user A indicated by the second information. For example, the processor 20 of the server 10 evaluates the user A on the basis of the first information and the second information in accordance with a predetermined criterion or evaluation items. The criterion or evaluation items may be specified by a user or the like who has requested the evaluation. For example, activities of the user A are evaluated.

The processor 20 of the server 10 outputs the information indicating the result of the evaluation of the user A (S06).

The information indicating the evaluation result may be transmitted to the terminal apparatus 12 of the user who has requested the evaluation or to the terminal apparatus 12A of the user A. Specifically, the information indicating the result of the evaluation of the user A may be provided to a user other than the user A or only to the user A. For example, the evaluation requester transmits the first information regarding the user A to the server 10 by using their terminal apparatus 12 and requests the server 10 to evaluate the user A. The processor 20 of the server 10 receives the request, acquires the second information regarding the user A, evaluates the user A on the basis of the first information and the second information regarding the user A, and provides the requester with the evaluation result.

If the second information regarding the user A indicating the activity history is not present in the Internet space (No in S03), the processor 20 of the server 10 evaluates the user A on the basis of the first information regarding the user A (S05) and outputs information indicating the evaluation result (S06).

For example, on the basis of a purchase history in the real space acquired from the first information and a purchase history in the Internet space acquired from the second information, the processor 20 of the server 10 infers a hobby, a taste, an asset size, or the like of a user for the evaluation of the user. The processor 20 of the server 10 may also infer the thought of the user for the evaluation of the user on the basis of an activity history in the real space acquired from the first information and a SNS posting history acquired from the second information. The processor 20 of the server 10 may also infer the lifestyle or the like of the user for the evaluation of the user on the basis of an activity history regarding the user in the real space acquired from the first information (such as gaming hours) and an activity history in the Internet space acquired from the second information (such as the type of the used game application software). The evaluation result may be used for personnel affairs, an employment activity, and the like.

The processor 20 of the server 10 may provide the user A with an additional question after receiving the first information regarding the user A. For example, the processor 20 of the server 10 transmits information indicating the additional question to the terminal apparatus 12A of the user A and causes the display of the terminal apparatus 12A to display the information. After the user A answers the additional question, information indicating the answer is transmitted from the terminal apparatus 12A to the server 10. The processor 20 of the server 10 includes the information indicating the answer in the first information and searches for the second information. The processor 20 of the server 10 may also evaluate the user A on the basis of the information indicating the answer, the first information, and the second information. For example, if a search is performed for an online service inferred as a service used by the user A, the user A is provided with, as the additional question, a question as to whether the account for using the online service is the account of the user A, a question about the use starting time of the online service, or the like. The processor 20 of the server 10 may search for the second information in such a manner as to include the answer in the first information or may evaluate the user A on the basis of the answer, the first information, and the second information. For example, if the retrieved second information has low reliability as the second information regarding the user A, the processor 20 of the server 10 provides the user A with an additional question.

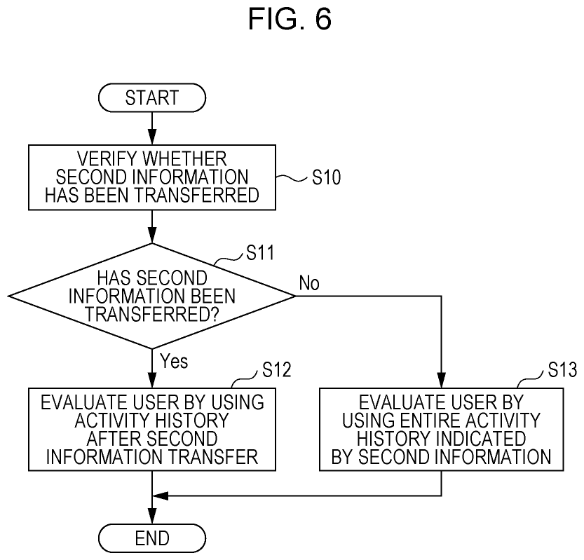

If the second information regarding a user has been transferred, the processor 20 of the server 10 may evaluate a user (that is, a transferee) who has received the second information, on the basis of an activity history after the transfer and evaluate a user who has transferred the second information (that is, a transferer), on the basis of an activity history before the transfer. This evaluation process will be described with reference to FIG. 6. FIG. 6 illustrates a flowchart of the process. The process is executed on the assumption that the processor 20 of the server 10 has acquired the second information regarding a user.

The processor 20 of the server 10 analyzes the second information regarding a user and thereby determines whether the second information has been transferred (S10). For example, if the second information includes information indicating a history of transferring the second information, the processor 20 of the server 10 determines that the second information has been transferred. If the second information does not include information indicating a history of transferring the second information, the processor 20 of the server 10 determines that the second information has not been transferred.

The transfer will be described in more detail. For example, if an account used in the Internet space is transferred, second information bound to the account includes information before the transfer and information after the transfer. The information before the transfer is information indicating an activity history in the Internet space regarding a user having transferred the account (transferer). The information after the transfer is information indicating an activity history in the Internet space regarding a user who has received the account (transferee). For example, if the account used in the Internet space has been transferred, the processor 20 of the server 10 determines that the second information bound to the account has been transferred.

If the second information (for example, the account) has been transferred (Yes in S11), the processor 20 of the server 10 evaluates the user who has received the second information (for example, the account), on the basis of the activity history after the transfer indicated by the second information and the activity history indicated by the first information (S12). In this case, the processor 20 of the server 10 may evaluate the user who has transferred the second information, on the basis of the activity history before the transfer indicated by the second information.

If the second information (for example, the account) has not been transferred (No in S11), the processor 20 of the server 10 evaluates the user on the basis of the activity history indicated by the second information and the activity history indicated by the first information (S13). Specifically, the processor 20 of the server 10 evaluates the user on the basis of the entire activity history indicated by the second information and the activity history indicated by the first information. For example, the user is evaluated by using the entire activity history after the generation of the account indicated by the second information.

The processor 20 of the server 10 may infer that the account has been transferred, on the basis of an activity history (such as the content of a post in SNS) indicated by the second information. The processor 20 may infer that the account has been transferred if an account name, a nickname, or the like is changed or if an image or the like bound to the account is changed.

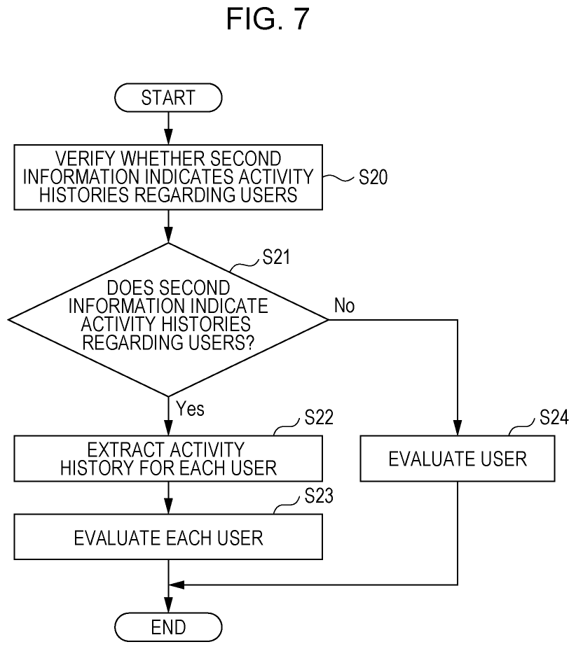

If the acquired second information indicates activity histories regarding users, the processor 20 of the server 10 may evaluate each user on the basis of the second information. This evaluation process will be described with reference to FIG. 7. FIG. 7 illustrates a flowchart of the process. The process is executed on the assumption that the processor 20 of the server 10 has acquired the second information.

The processor 20 of the server 10 analyzes the acquired second information and thereby determines whether the second information indicates activity histories regarding users (S20). For example, if users use an online service or the like by using the same account, the second information bound to the account is acquired by the server 10. The second information is information bound to the one account but is actually information indicating activity histories regarding the users.

The processor 20 of the server 10 analyzes each activity history indicated by the second information and thereby determines whether the second information indicates the activity histories regarding the users. For example, if the activity histories indicated by the second information include completely different activity histories (such as a history of purchasing a commodity, a SNS posting history, and a SNS browsing history), there is a possibility that the activity histories are activity histories regarding the respective different users. In this case, the processor 20 of the server 10 infers each activity history as an activity history regarding a corresponding one of the users. For example, if the activity histories indicated by the second information include a history of purchasing a commodity A (for example, a men's commodity) and a history of purchasing a commodity B (for example, a women's commodity) in a field completely different from the field of the commodity A, the processor 20 of the server 10 infers the history of purchasing the commodity A and the history of purchasing the commodity B as activity histories regarding respective different users. In another example, if the activity histories indicated by the second information include a history of purchasing a commodity C (for example, an adult's commodity) and a history of purchasing a commodity D (for example, a children's commodity) in a field completely different from the field of the commodity C, the processor 20 of the server 10 infers the history of purchasing the commodity C and the history of purchasing the commodity D as activity histories regarding respective different users. In a still another example, if the activity histories indicated by the second information include histories of purchasing commodities E and F, and if the time of day when the commodity E is purchased is completely different from the time of day when the commodity F is purchased, the processor 20 of the server 10 infers the history of purchasing the commodity E and the history of purchasing the commodity F as activity histories regarding respective different users.

If the second information indicate the activity histories regarding the users (Yes in S21), the processor 20 of the server 10 separately extracts each activity history regarding the corresponding user from the activity histories indicated by the second information (S22) and evaluates each user on the basis of the activity history regarding the user (S23). An activity history not extracted from the activity histories indicated by the second information (that is, an activity history regarding an unknown user) is not used for evaluation.

If the second information does not indicate the activity histories regarding users but indicates an activity history regarding one user (No in S21), the processor 20 of the server 10 evaluates the one user by using the activity history indicated by the second information (S24).

Note that the first information may be information indicating activity histories regarding users. For example, the users may form a team, a group, or an organization, and the first information may be information indicating an activity history regarding the team, the group, or the organization in the real space. The first information may be information indicating an activity history regarding the family of users. The processor 20 of the server 10 may evaluate the team, the group, or the organization by using the first information as described above. If the activity of the team, the group, or the organization is not determined, the processor 20 of the server 10 may provide an additional question to the users belonging to the team, the group, or the organization and thereby may determine the activity of the team, the group, or the organization on the basis of answer to the question.

The processor 20 of the server 10 may execute a weighting process on the first information and the second information and thereby evaluate a user. For example, the processor 20 of the server 10 evaluates the user in such a manner to set a higher weighting coefficient for a more highly objective information. More highly objective information is inferred as more highly credible information, and the weighting coefficient of the information is set higher. Examples of highly objective first information include location information and biometric information regarding the user. Examples of highly objective second information include information authenticated by a certification authority. Examples of the certification authority include an authentication-service-providing body and a standardization organization. The certification authority may be a public body (for example, a national or public organization) and may be a private body. As an example of the authentication service provided by the public body, the Basic Residents' Registration Network may be cited. For example, the second information authenticated by a predetermined certification authority is inferred as highly objective information, and thus a high weighting coefficient is set for the information. If there is more than one certification authority, the weighting coefficient may be varied in accordance with the certification authority.

For evaluating the user, the processor 20 of the server 10 may use the above-described information authenticated by the certification authority in the second information without using the information not authenticated by the certification authority in the second information. Since the second information authenticated by the certification authority is inferred as highly credible information, using the second information authenticated by the certification authority enables the user to be evaluated more appropriately.

The second information may be managed by using technology for synchronizing and recording data such as a blockchain. The occurrence, distribution, discarding, and deletion of the second information may be strictly managed in a time series. In addition, the processor 20 of the server 10 may evaluate the user by using the second information managed in this manner.

The processor 20 of the server 10 may infer the change of a user indicated by the second information, on the basis of the second information. For example, if an account, a nickname, or the like indicated by the second information is changed, or if the second information includes information indicating an account purchase history, the processor 20 of the server 10 infers that the user indicated by the second information has changed. In addition, if the second information includes information regarding a post by a user in an SNS, information indicating a posting history, or information indicating a history of browsing a SNS by a user, the processor 20 of the server 10 analyzes the content of the post, the posting history, the browsing history, or the like and thereby infers whether the user indicated by the second information has changed. For example, if a SNS is used with the same account, but if there is a change in the content of a post in a SNS, the time of day of posting, SNS browsing details, or the time of day of browsing, the processor 20 of the server 10 infers that the user using the account has changed. In other words, the processor 20 of the server 10 infers that different users have used the same account before and after the change. If it is inferred that the user indicated by the second information has changed, the processor 20 of the server 10 sets each of the second information before the change and the second information after the change as the second information regarding a corresponding one of the users and uses the second information for evaluating the user.

Note that the processes described above may be executed by the processor 28 of the terminal apparatus 12. Specifically, the process for acquiring the second information on the basis of the first information and the process for evaluating a user on the basis of the first information and the second information may be executed by the processor 28 of the terminal apparatus 12.

The functions of the respective components of each of the server 10 and the terminal apparatus 12 are implemented, for example, in cooperation between hardware and software. For example, the processor of each apparatus reads out and runs a program stored in the memory of the apparatus, and thereby the corresponding function of the apparatus is implemented. The program is stored in the memory via a recording medium such as a compact disc (CD) or a digital versatile disc (DVD) or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
on a basis of first information indicating an activity history regarding at least one user in real space, acquire second information present in Internet space and indicating an activity history regarding the at least one user.

2. The information processing apparatus according to claim 1,
wherein the first information and the second information each include a plurality of items, and
wherein the processor is configured to:
acquire the second information when the second information has at least one of the items content of which coincides with content of at least one of the items in the first information and the number of which is larger than or equal to a threshold.

3. The information processing apparatus according to claim 1,
wherein the first information includes biometric information regarding the user.

4. The information processing apparatus according to claim 2,
wherein the first information includes biometric information regarding the user.

5. The information processing apparatus according to claim 1,
wherein the second information includes information indicating a history of purchasing and selling an account of the user.

6. The information processing apparatus according to claim 2,
wherein the second information includes information indicating a history of purchasing and selling an account of the user.

7. The information processing apparatus according to claim 3,
wherein the second information includes information indicating a history of purchasing and selling an account of the user.

8. The information processing apparatus according to claim 1,
wherein the processor is further configured to:
make an inquiry to the user about what the user needs to know to validate the activity history indicated by the second information, and include answer from the user to the inquiry in the first information; and
acquire the second information.

9. The information processing apparatus according to claim 1,
wherein the processor is configured to:
when a plurality of the users use one account, discriminate each user and acquire the second information for each user.

10. The information processing apparatus according to claim 9,
wherein the processor is configured to:
discriminate each user on a basis of a language used by the user.

11. The information processing apparatus according to claim 9,
wherein the processor is configured to:
discriminate each user on a basis of time of day of an activity of the user.

12. The information processing apparatus according to claim 1,
wherein the second information includes information indicating an activity history regarding an agent who acts on behalf of the user by using an account of the user in the Internet space.

13. The information processing apparatus according to claim 1,
wherein the processor is further configured to:
evaluate the user on a basis of the first information and the second information.

14. The information processing apparatus according to claim 13,
wherein the processor is configured to:
if the second information has experienced transfer, evaluate one of the users who has received the second information, the user being evaluated on a basis of an activity history after the transfer.

15. The information processing apparatus according to claim 13,
wherein the processor is configured to:
when the second information indicates activity histories regarding a plurality of the users, evaluate each user.

16. The information processing apparatus according to claim 13,
wherein the processor is configured to:
execute a weighting process on each of the first information and the second information and evaluate the user.

17. The information processing apparatus according to claim 13,
wherein the processor is configured to:
use information authenticated by a certification authority in the second information, the information being used to evaluate the user.

18. The information processing apparatus according to claim 1,
wherein the processor is further configured to:
infer change of the user indicated by the second information, the change being inferred on a basis of the second information.

19. An information processing method comprising:
on a basis of first information indicating an activity history regarding a user in real space, acquiring second information that is present in Internet space and that indicates an activity history regarding the user.

20. A non-transitory computer readable medium storing a program causing a computer to execute a process comprising:
on a basis of first information indicating an activity history regarding a user in real space, acquiring second information that is present in Internet space and that indicates an activity history regarding the user.
